(19) United States
(12) Patent Application Publication
(10) Pub. No.: US 2006/0002685 A1
(43) Pub. Date: Jan. 5, 2006

(54) Audio video system capable of transferring image files to external device and image file transfer method therefor

(75) Inventor: Yong-Ju Jeong, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co. Ltd.

(21) Appl. No.: 11/168,356

(22) Filed: Jun. 29, 2005

(30) Foreign Application Priority Data
Jun. 30, 2004 (KR) 2004-50045

(51) Int. Cl. H04N 5/91; H04N 5/781

(52) U.S. Cl. 386/94; 386/125

(57) ABSTRACT

Disclosed is an AV system capable of sending image files to an external device and an image file transfer method therefor. The AV system capable of performing at least one of an image-capturing function, image-receiving function, image-recording function, and image-reproducing function, comprises a communication interface unit for performing data communications with an external device; a recording medium for storing image files; an input unit; and a controller for, if a file transfer command is inputted through the input unit, controlling the communication interface unit to send a ‘file transfer allowable’ request to the external device, and, if the communication interface unit receives a ‘file transfer allowable’ response from the external device, controlling the communication interface unit to send the image files stored in the recording medium to the external device.

### CROSS-REFERENCE TO REFERENCE TO RELATED APPLICATION

This application claims the benefit under 35 U.S.C. §119(a) of Korean Patent Application No. 2004-50045, filed on Jun. 30, 2004, in the Korean Intellectual Property Office, the entire disclosure of which is hereby incorporated by reference.

### BACKGROUND OF THE INVENTION

1. Field of the Invention

The present invention relates to an audio video (AV) system and an image file transfer method therefor. More particularly, the present invention relates to an AV system image file transfer method capable of sending image files to an external device to store in the external device the image files recorded in a recording medium.

2. Description of the Related Art

AV systems are capable of reproducing internally-produced or externally-received image data, storing in the recording media the image data as image files, or playing the image files. There are digital cameras and digital camcorders, as typical examples of such AV systems, for reproducing the internally-produced image data, and there are MP3 players, as typical examples of such AV systems, for reproducing the received image data.

The AV system is provided with a recording medium of relatively small storage capacity, and, in particular, portable AV systems have a recording medium of much smaller storage capacity. Thus, if one wishes to store new image data over and over in a recording medium of his or her AV system, he or she moves the image files stored in the recording medium of the AV system to an external device having a recording medium with a large storage capacity, so as to recover a storage space in the recording medium of the AV system.

To do so, most AV systems provide an AV system-to-PC file transfer function for sending image files stored in a recording medium to a PC. The AV system-to-PC file transfer function can be carried out by connecting the AV system and the PC by cable, selecting image files to be sent and a folder where the image files are to be transferred by using an application program installed in the PC, and inputting a file transfer command.

As described above, users have to use the PC in order to manipulate the input operations for AV system-to-PC file transfers, since such input operations through the PC give the users more convenience than those through the AV system.

However, such input operations through the PC can be rather inconvenient to the users unfamiliar with the operations of the PC. Further, if such users are unfamiliar with the tasks for installing application programs in the PC prior to transferring files between AV systems and the PC, they may think the file transfers are difficult tasks.

Further, since the AV system-to-PC file transfers are being done through a cable, the AV system-to-PC file transfer tasks have to be performed where the PC is located. As such, the input operations for AV system-to-PC file transfers are available only through the PC, but users are inconvenienced by such limitations.

However, if a wireless communication interface is realized among devices such as Bluetooth, the AV system-to-PC file transfers can be done in a wireless manner, so that, in order to do the AV system-to-PC file transfer tasks, users are not limited to performing file transfer tasks at the locations where the PC is located. However, if users can only perform the file transfer tasks through the PC using the input operations of an AV system-to-PC file transfers, there occurs a problem in that the users can only perform the AV system-to-PC file transfer tasks only at the location where the PC is located.

### SUMMARY OF THE INVENTION

The present invention has been developed in order to solve the above drawbacks and other problems associated with the conventional arrangement. An aspect of the present invention is to provide an AV system and image file transfer method therefor capable of transferring image files stored on recording media to external devices such as PCs through input operations on the AV system.

The foregoing and other objects and advantages are substantially realized by providing an AV system capable of performing at least one of an image-capturing function, image-receiving function, image-recording function, and image-reproducing function, comprising a communication interface unit for performing data communications with an external device; a recording medium for storing image files; an input unit; and a controller for controlling the communication interface unit to send a ‘file transfer allowable’ request to the external device, if a file transfer command is input through the input unit, and, if the communication interface unit receives a ‘file transfer allowable’ response from the external device, controlling the communication interface unit to send the image files stored in the recording medium to the external device.

Further, if image files to be sent are selected through the input unit, the controller includes in the ‘file transfer allowable’ request information the names of the selected image files.

Further, if the communication interface unit receives a ‘file transfer unallowable’ response from the external device, the controller controls the communication interface unit to re-send to the external device the ‘file transfer allowable’ request including changed file names input through the input unit.

Further, if a folder on the recording medium of the external device to which the image files are to be transferred is selected through the input unit, the controller includes in the ‘file transfer allowable’ request information comprising the name of the selected folder.

Further, if the communication interface unit receives a ‘file transfer unallowable’ response from the external device, the controller controls the communication interface unit to re-send to the external device the ‘file transfer allowable’ request including at least one of the changed file and folder names input through the input unit.

Further, the external device is preferably a personal computer (PC), and the communication interface unit performs data communications with the external device according to any of a USB interface mode, an IEEE 1394 interface mode, and/or a wireless communication mode.

In the meantime, the foregoing and other objects and advantages are substantially realized by providing an image file transfer method for an AV system capable of performing at least one of an image-capturing function, image-receiving function, image-recording function, and image-reproducing function, comprising the steps of a) if a file transfer command is input through an input unit provided on the AV system, sending a ‘file transfer allowable’ request to an external device; and b) if a ‘file transfer allowable’ response is received from the external device, sending to the external device image files stored in a recording medium provided in the AV system.

Further, in step a), if image files to be sent are selected through the input unit, the controller includes in the ‘file transfer allowable’ request information comprising the names of the selected image files.

Further, the image file transfer method further comprises a step of, if a ‘file transfer unallowable’ response is received from the external device, re-sending to the external device the ‘file transfer allowable’ request information comprising the changed file names input through the input unit.

Further, in step a), if a folder on the recording medium of the external device to which the image files are to be transferred is selected through the input unit, the controller includes in the ‘file transfer allowable’ request information comprising a name of the selected folder.

Further, the image file transfer method further comprises a step of, if the ‘file transfer unallowable’ response is received from the external device, re-sending to the external device the ‘file transfer allowable’ request with information including at least one of the changed file and folder names re-inputted through the input unit.

The external device is preferably a personal computer (PC), and exemplary AV systems can include any of a CD player, a DVD player, an HDD player, a memory card-mountable player, a digital camera, a digital camcorder, a mobile phone, a personal digital assistant (PDA), a TV set, a MP3 player, an audio system, and a combination AV system with any of the above players selectively combined.

### BRIEF DESCRIPTION OF THE DRAWINGS

The above aspects and features of the present invention will be more apparent by describing certain embodiments of the present invention with reference to the accompanying drawings, in which:

FIG. 1 is a block diagram showing an AV system capable of transferring image files to external devices through input operations on the AV system according to an embodiment of the present invention; and

FIG. 2 is a flow chart explaining an exemplary process for transferring image files to external devices through input operations on an AV system according to an embodiment of the present invention.

Throughout the drawings, it should be understood that like reference numbers refer to like features, structures and elements.

### DETAILED DESCRIPTION OF EXEMPLARY EMBODIMENTS

Embodiments of the present invention will now be described in detail with reference to the accompanying drawings.

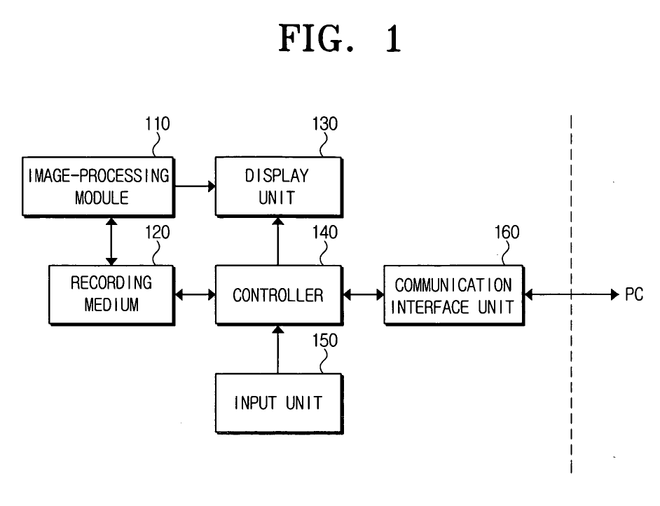

FIG. 1 is a block diagram showing an AV system capable of transferring image files to external devices through input operations on the AV system according to an embodiment of the present invention. In FIG. 1, the AV system according to an embodiment of the present invention has an image-processing module 110, a recording medium 120, a display unit 130, a controller 140, an input unit 150, and a communication interface unit 160. Further, the AV system can be connected to a personal computer (PC), for example, as an external device in a wired or wireless manner.

The image-processing module 110 is a module for carrying out an image-capturing function, image-receiving function, image-recording function, image-reproducing function, and so on. In detail, the image-capturing function refers to a function for generating an image signal preferably by use of a lens and a charge-coupled device (CCD) or the like, and the image-receiving function refers to a function for receiving broadcast signals and external input signals through an antenna, cable, and so on. Further, the image-recording function refers to a function of recording the generated and/or received image data in the recording medium 120 as image files, and the image-reproducing function refers to a function of reproducing and displaying the image files recorded in the recording medium 120 on the display unit 130.

The image-processing module 110 does not have to be implemented to carry out all the above functions, that is, the image-capturing function, image-receiving function, image-recording function, and the image-reproducing function. That is, the image-processing module 110 has functions determined depending on the type of AV system being implemented. For example, as for the digital camera or the digital camcorder, the image-processing module 110 does not have to be implemented to have the broadcast signal-receiving function, and, as for the MP3 player, the image-processing module 110 does not have to be implemented to have the image-capturing function.

The recording medium 120 stores the image files generated and/or received by the image-processing module 110 and the image files transferred through the communication interface unit 160. The image files can be classified into moving-picture files, still image files, audio files, and so on. Further, the recording medium 120 can have plural folders therein so that image files are sorted and stored in corresponding folders. For example, one can have moving-picture files stored in a moving-picture folder, still image files in a still image folder, and audio files in an audio folder.

The recording medium 120 may be semiconductor memories, compact discs (CDs), digital video discs (DVDs), hard disc drives (HDDs), memory cards, and so on, but, any medium that can store image files can be used as the recording medium 120.

The display unit 130 is a display unit for displaying images generated, received, and reproduced through the image-processing module 110 as well as user interface windows provided by the controller 140.

The communication interface unit 160 carries out data communications with a PC under the controls of the controller 140. Any communication mode can be used for the communications between the communication interface unit 160 and the PC. In detail, the communication interface unit 160 and the PC can perform data communications therebetween in a universal serial bus (USB) interface mode, an IEEE 1394 interface mode, and on the like. In addition, the communication interface unit 160 and the PC can also perform data communications therebetween in the wireless communication interface mode, such as Bluetooth, WiFi or other suitable method.

The input unit 150 is a user interface unit for inputting and sending users' operation commands to the controller 140. In particular, the input unit 150 is used to receive input commands necessary for the AV system-PC file transfers. The input commands necessary for the AV system-PC file transfers may be i) input commands for AV system-PC file transfer commands, ii) input commands for selecting image files to be transferred, iii) input commands for selecting folders on the HDD of the PC to which the selected image files are to be transferred, and so on.

The controller 140 drives the AV system according to a user's operation command sent through the input unit 150, as well as control signals for the overall operation of the AV system. In particular, the controller 140 performs a series of processing steps required for the AV system-PC file transfers.

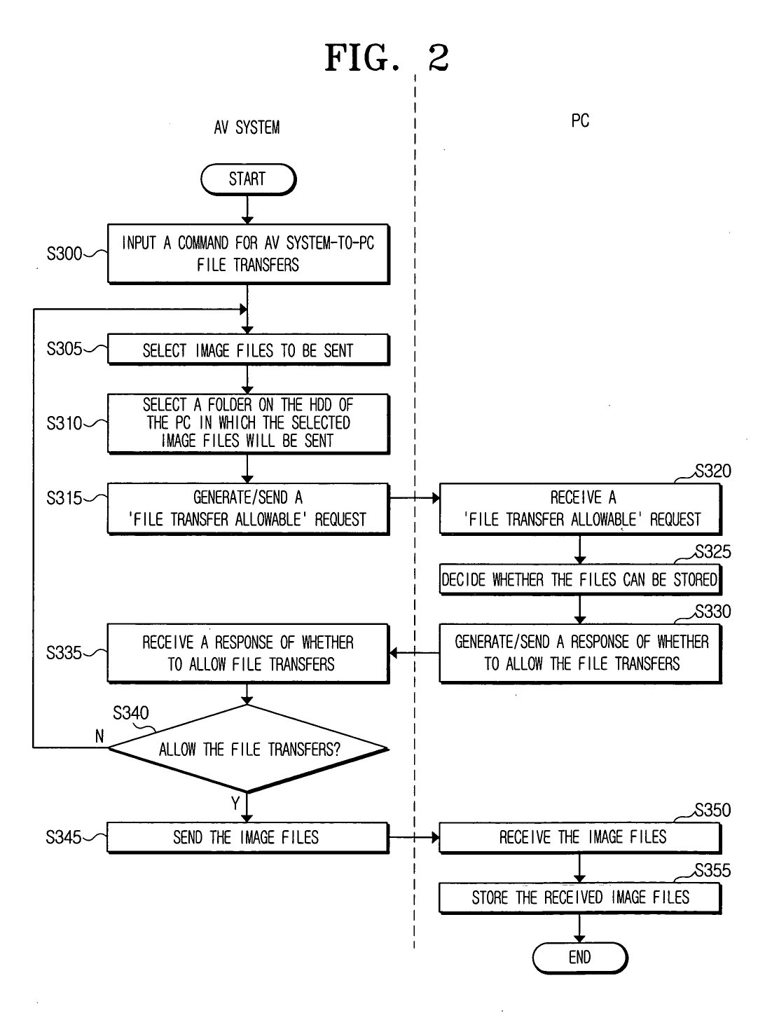

A description will now be made in more detail of a process for the AV system of FIG. 1 to send image files recorded in the recording medium 120 to a PC as an external device, with reference to FIG. 2. FIG. 2 is a flow chart explaining an exemplary process of sending image files to an external device through user's input operations on the AV system, according to an embodiment of the present invention. In FIG. 2, for ease of understanding, the processing steps shown on the left are carried out in the AV system, and the processing steps shown on the right are carried out in the PC.

Prior to the AV system-PC file transfers, a user connects an AV system to a PC in a wired or wireless manner, and carries out input operations necessary for the AV system-PC file transfers through the AV system rather than the PC (See steps S300, S305, and S310).

In detail, a user inputs a command for the AV system-to-PC file transfers through the input unit 150 provided on the AV system (S300), selects image files of the image files stored in the recording medium 120 that will be sent to the PC (S305), and selects a folder on the HDD of the PC to which the selected image files will be sent (S310).

The user's input operations in the steps S300 to S310 can be accomplished through cursor movements on a user interface window, that is, preferably, a menu window, which the controller 140 provides the user through the display unit 130.

Further, in the step S305, the controller 140 causes the display unit 130 to display a list of image files stored in the recording medium 120 so that the user can refer to the list when selecting image files. In the step S305, the user can select one, some, or all image files. Further, the user can select all image files by image file types, which means that, for example, the user can select all moving-picture files, still image files, or audio files stored in the recording medium 120 with one input operation.

Further, in the step S310, the controller 140 causes the display unit 130 to display a list of folders existing on the HDD of the PC so that a user can refer to the list when selecting folders for an input. Besides, the user can select, for an input, a folder on the HDD of the PC in which image files will be sent to have the same folder name as a folder on the recording medium 120 of an AV system in which the image files are currently stored.

If the user's input operations are completed through the steps S300 to S310, the controller 140 generates a request for ‘file transfer allowable’ by using the selected input information, and sends the request to the PC through the communication interface unit 160 (S315). The ‘file transfer allowable’ request information preferably includes the file names of the image files selected for the input in the step S305 and the folder name of the folder selected for the input in the step S310.

If the PC receives the ‘file transfer allowable’ request (S320), the PC decides by use of the request whether the files can be stored (S325). Further, as a response to the ‘file transfer allowable’ request of the AV system, the PC generates a response as to whether to allow the file transfer based on the result of the decision in step S325, and sends the generated response to the AV system (S330).

In detail, the PC refers to the file names and the folder name included in the ‘file transfer allowable’ request, looks up whether the image files having the same names exist in the same folder name on its HDD, and decides whether the files can be stored.

In the step S330, the communication interface unit 160 of the AV system receives the response of whether to allow the file transfer that has been sent by the PC (S335). If the response to whether to allow the file transfer that has been received in the step S335 is determined to be the ‘file transfer allowable’ response (S340), the controller 140 reads from the recording medium 120 the image files selected for input in the step S305 and sends the image files to the PC through the communication interface unit 160 (S345).

Next, the PC receives the sent image files (S350), refers to the folder name included in the ‘file transfer allowable’ request received in the step S320, and stores the received image files in the folder having the same folder name as one in the HDD (S355).

Meanwhile, if the response of whether to allow the file transfer that has been received in the step S335 is determined to be a ‘file transfer unallowable’ response (S340), the controller 140 proceeds through steps S305 and S310 again to receive a changed file name and/or folder name again from the user, generates and sends again the ‘file transfer allowable’ request including the file name and/or folder name that were input.

The embodiments of the present invention refer to the PC as an external device connected to the AV system. However, the PC is merely one example, and the external device that can be connected to the AV system is not limited to the PC. Therefore, the present invention can be applied to the case where one AV system is connected to another AV system for file transfers therebetween.

Further, there is no limit to the types of AV systems to which the present invention is applied. That is, embodiments of the present invention can be applied to any AV system, if the AV system can perform at least one of the functions of generating, receiving, reproducing, and storing images. Accordingly, embodiments of the present invention can be applied to CD players, DVD players, HDD players, memory card-mountable players, digital cameras, digital camcorders, mobile phones, PDAs, TV sets, set-top boxes, MP3 players, audio systems, and combination AV systems comprising a combination of the above players.

As described above, embodiments of the present invention enable one to send image files stored in a recording medium of an AV system to external devices such as PCs through input operations on the AV system. Thus, even users unfamiliar with the operations of PCs can easily use the AV system-to-PC file transfer function. Additionally, a user can perform the AV system-to-PC file transfers through an AV system even in the places where PCs are not located.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. An audio video (AV) system capable of performing at least one of an image-capturing function, image-receiving function, image-recording function, and image-reproducing function, comprising:
a communication interface unit for performing data communications with an external device;
a recording medium for storing image files;
an input unit; and
a controller for controlling the communication interface unit to send a ‘file transfer allowable’ request to the external device, if a file transfer command is input through the input unit, and, if the communication interface unit receives a ‘file transfer allowable’ response from the external device, controlling the communication interface unit to send the image files stored in the recording medium to the external device.

2. The AV system as claimed in claim 1, wherein, if image files to be sent are selected through the input unit, the controller includes in the ‘file transfer allowable’ request information comprising names of the selected image files.

3. The AV system as claimed in claim 2, wherein, if the communication interface unit receives a ‘file transfer unallowable’ response from the external device, the controller controls the communication interface unit to send to the external device the ‘file transfer allowable’ request comprising changed file names input through the input unit.

4. The AV system as claimed in claim 2, wherein, if a folder on the recording medium of the external device to which the image files are to be transferred is selected through the input unit, the controller includes in the ‘file transfer allowable’ request information comprising the name of the selected folder.

5. The AV system as claimed in claim 4, wherein, if the communication interface unit receives a ‘file transfer unallowable’ response from the external device, the controller controls the communication interface unit to re-send to the external device the ‘file transfer allowable’ request comprising at least one of the changed file and folder names re-inputted through the input unit.

6. The AV system as claimed in claim 1, wherein the external device is a personal computer (PC).

7. The AV system as claimed in claim 1, wherein the communication interface unit performs data communications with the external device according to any of a USB interface mode, an IEEE 1394 interface mode, and a wireless communication mode.

8. An image file transfer method for an AV system capable of performing at least one of an image-capturing function, image-receiving function, image-recording function, and image-reproducing function, comprising the steps of:
a) if a file transfer command is input through an input unit provided on the AV system, sending from an audio video (AV) system a ‘file transfer allowable’ request to an external device; and
b) if a ‘file transfer allowable’ response is received from the external device, sending from the AV system to the external device image files stored in a recording medium provided in the AV system.

9. The image file transfer method as claimed in claim 8, wherein step a) further comprises the step of:
if image files to be sent are selected through the input unit, including in the ‘file transfer allowable’ request information the names of the selected image files.

10. The image file transfer method as claimed in claim 9, further comprising a step of:
if a ‘file transfer unallowable’ response is received from the external device, re-sending from an AV system to the external device the ‘file transfer allowable’ request information including changed file names input through the input unit.

11. The image file transfer method as claimed in claim 9, wherein step a) further comprises the step of:
if a folder on the recording medium of the external device to which the image files are to be transferred is selected through the input unit, including in the ‘file transfer allowable’ request information a name of the selected folder.

12. The image file transfer method as claimed in claim 11, further comprising a step of:
if the ‘file transfer unallowable’ response is received from the external device, re-sending to the external device the ‘file transfer allowable’ request information including at least one of the changed file and folder names input through the input unit.

13. The image file transfer method as claimed in claim 8, wherein the external device is a personal computer (PC).

14. The image file transfer method as claimed in claim 8, wherein the AV system is any of a CD player, a DVD player, an HDD player, a memory card-mountable player, a digital camera, a digital camcorder, a mobile phone, a personal digital assistant (PDA), a TV, a set top box, an MP3 player, an audio system, and a combination AV system comprising any combination thereof.

15. The image file transfer method as claimed in claim 8, wherein the external device is an AV system comprising any of a CD player, a DVD player, an HDD player, a memory card-mountable player, a digital camera, a digital camcorder, a mobile phone, a personal digital assistant (PDA), a TV, a set top box, an MP3 player, an audio system, and a combination AV system comprising any combination thereof.
